(19) United States
(12) Patent Application Publication
(10) Pub. No.: US 2004/0105743 A1
(43) Pub. Date: Jun. 3, 2004

(54) Tilting flatbed trailer system

(76) Inventor: Eric E. Franklund, Mandan, ND (US)

Correspondence Address: Michael S. Neustel, Suite No. 4, 2534 South University Drive, Fargo, ND, 58103, US

(21) Appl. No.: 10/309,513

(22) Filed: Dec. 3, 2002

(51) Int. Cl. B60P 1/04

(52) U.S. Cl. 414/482

(57) ABSTRACT

A tilting flatbed trailer system for facilitating safe and efficient loading/unloading of cargo. The tilting flatbed trailer system includes a main frame, a plurality of end rollers rotatably attached to the main frame, a hydraulic cylinder attached to the main frame, a bed frame slidably positioned upon the main frame and connected to the hydraulic cylinders, and a plurality of support arms pivotally attached to the main frame and slidably connected to the bed frame. When the hydraulic cylinder is extended, the front of the bed frame is elevated and the bed frame simultaneously slides rearwardly thereby providing a low incline for loading/unloading cargo.

### CROSS REFERENCE TO RELATED APPLICATIONS

Not applicable to this application.

### STATEMENT REGARDING FEDERALLY SPONSORED RESEARCH OR DEVELOPMENT

Not applicable to this application.

### BACKGROUND OF THE INVENTION

1. Field of the Invention

The present invention relates generally to trailers and more specifically it relates to a tilting flatbed trailer system for facilitating safe and efficient loading/unloading of cargo.

2. Description of the Related Art

Trailers including flat-bed trailers have been in use for years. A conventional flat-bed trailer is comprised of a rigid frame structure, a plurality of wheels rotatably attached to the frame structure, and a hitch extending from the front end of the frame for connecting to a vehicle. Tilt-bed trailers have been recently utilized which allow for the direct loading of cargo onto the tilt-bed trailer by pivoting the bed with respect to the frame.

The main problem with conventional flat-bed trailers is that they require the operator to either lift the cargo onto the trailers or to utilize removable ramps. Manually or mechanically lifting cargo onto a trailer can be unsafe and hazardous. In addition, utilizing ramps is cumbersome and can be dangerous if the ramps are not properly utilized. Tilt-bed trailers often times create a significant incline which makes loading cargo difficult and unsafe.

Examples of patented devices which may be related to the present invention include U.S. Pat. No. 4,568,235 to Bills, Jr.; U.S. Pat. No. 4,702,662 to Marlett; U.S. Pat. No. 5,667,231 to Dierks et al.; U.S. Pat. No. 5,730,572 to Scheuren; U.S. Pat. No. 4,704,062 to Hale; U.S. Pat. No. 2,812,088 to Cadillac et al.; U.S. Pat. No. 3,035,728 to Hecker; U.S. Pat. No. 3,720,336 to Murray et al.; U.S. Pat. No. 4,168,932 to Clark; U.S. Pat. No. 5,059,085 to Koller; and U.S. Pat. No. 5,779,431 to Alm et al.

While these devices may be suitable for the particular purpose to which they address, they are not as suitable for facilitating safe and efficient loading/unloading of cargo. Conventional trailers in use today do not allow for the efficient loading/unloading of cargo upon the trailer.

In these respects, the tilting flatbed trailer system according to the present invention substantially departs from the conventional concepts and designs of the prior art, and in so doing provides an apparatus primarily developed for the purpose of facilitating safe and efficient loading/unloading of cargo.

### BRIEF SUMMARY OF THE INVENTION

In view of the foregoing disadvantages inherent in the known types of vehicle trailers now present in the prior art, the present invention provides a new tilting flatbed trailer system construction wherein the same can be utilized for facilitating safe and efficient loading/unloading of cargo.

The general purpose of the present invention, which will be described subsequently in greater detail, is to provide a new tilting flatbed trailer system that has many of the advantages of the trailers mentioned heretofore and many novel features that result in a new tilting flatbed trailer system which is not anticipated, rendered obvious, suggested, or even implied by any of the prior art trailers, either alone or in any combination thereof.

To attain this, the present invention generally comprises a main frame, a plurality of end rollers rotatably attached to the main frame, a hydraulic cylinder attached to the main frame, a bed frame slidably positioned upon the main frame and connected to the hydraulic cylinders, and a plurality of support arms pivotally attached to the main frame and slidably connected to the bed frame. When the hydraulic cylinder is extended, the front of the bed frame is elevated and the bed frame simultaneously slides rearwardly thereby providing a low incline for loading/unloading cargo.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a tilting flatbed trailer system that will overcome the shortcomings of the prior art devices.

A second object is to provide a tilting flatbed trailer system for facilitating safe and efficient loading/unloading of cargo.

Another object is to provide a tilting flatbed trailer system that does not require loading ramps.

An additional object is to provide a tilting flatbed trailer system that does not require cargo to be manually or mechanically lifted onto the bed of the trailer..

A further object is to provide a tilting flatbed trailer system that decreases the loading angle of the flat-bed trailer.

Another object is to provide a tilting flatbed trailer system that is capable of loading and supporting various types of cargo including but not limited to vehicles, tractors, heavy equipment and the like.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is a side view of the present invention.

FIG. 3 is a side view of the present invention being pivoted and extended rearwardly for loading/unloading of cargo.

FIG. 4 is a side view of the present invention being pivoted and retracted forwardly.

FIG. 5 is a bottom view of the present invention.

FIG. 6 is a top partial cutaway view of the present invention.

FIG. 7 is a top partial cutaway view of the present invention.

### DETAILED DESCRIPTION OF THE INVENTION

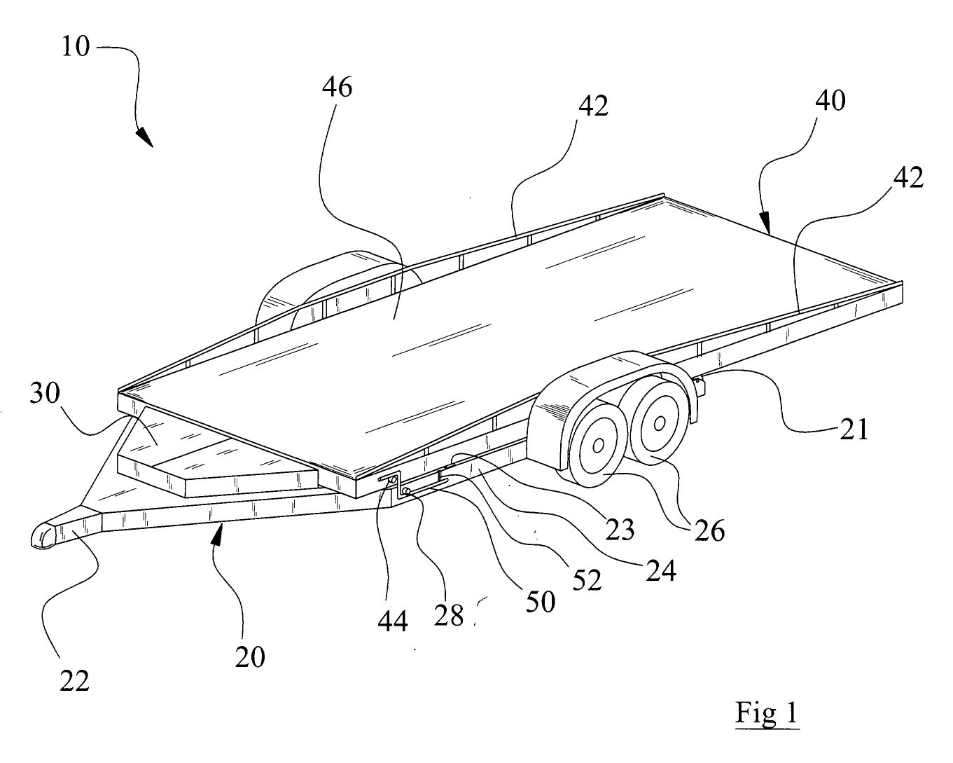

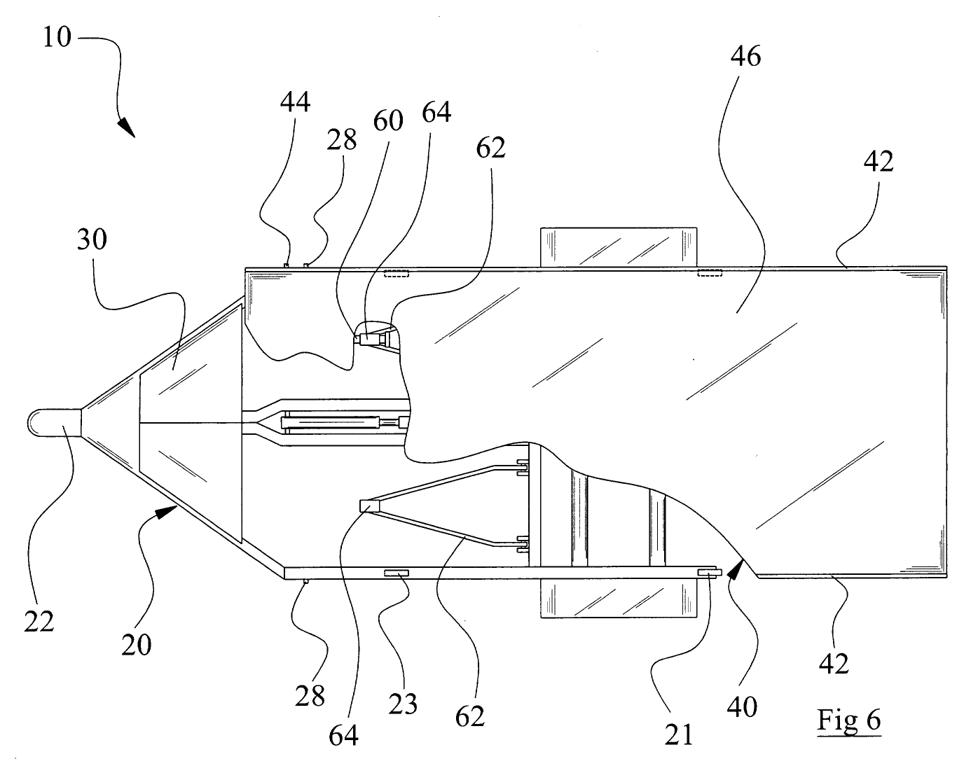

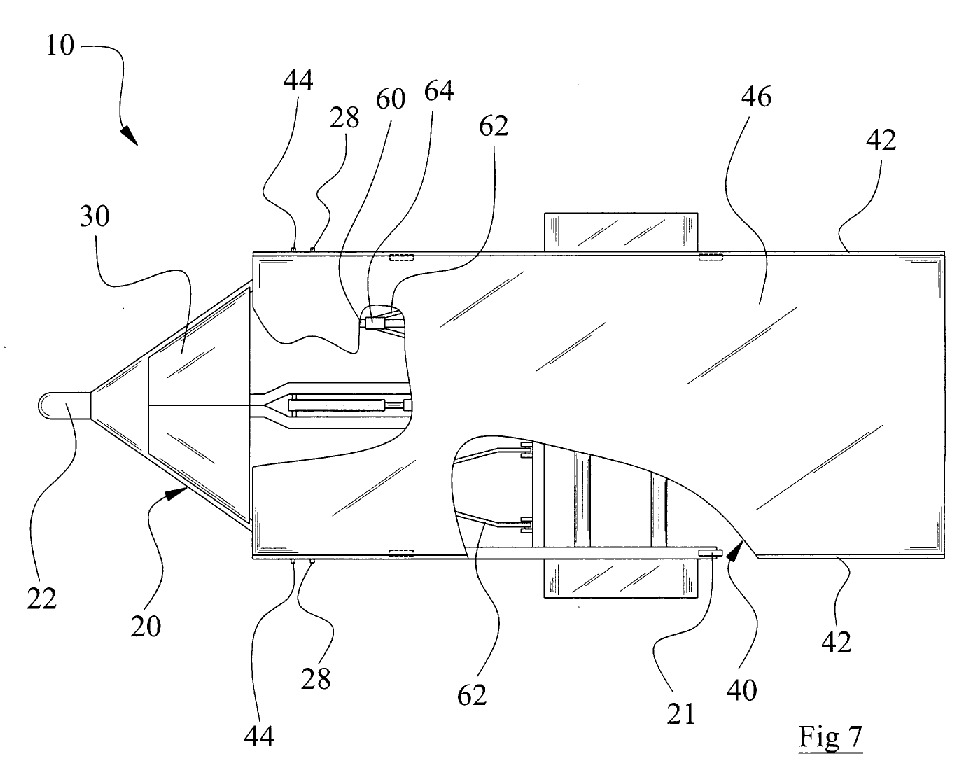

Turning now descriptively to the drawings, in which similar reference characters denote similar elements throughout the several views, FIGS. 1 through 7 illustrate a tilting flatbed trailer system 10, which comprises a main frame 20, a plurality of end rollers 21 rotatably attached to the main frame 20, a hydraulic cylinder attached to the main frame 20, a bed frame 40 slidably positioned upon the main frame 20 and connected to the hydraulic cylinders 70, and a plurality of support arms 62 pivotally attached to the main frame 20 and slidably connected to the bed frame 40. When the hydraulic cylinder is extended, the front of the bed frame 40 is elevated and the bed frame 40 simultaneously slides rearwardly thereby providing a low incline for loading/unloading cargo.

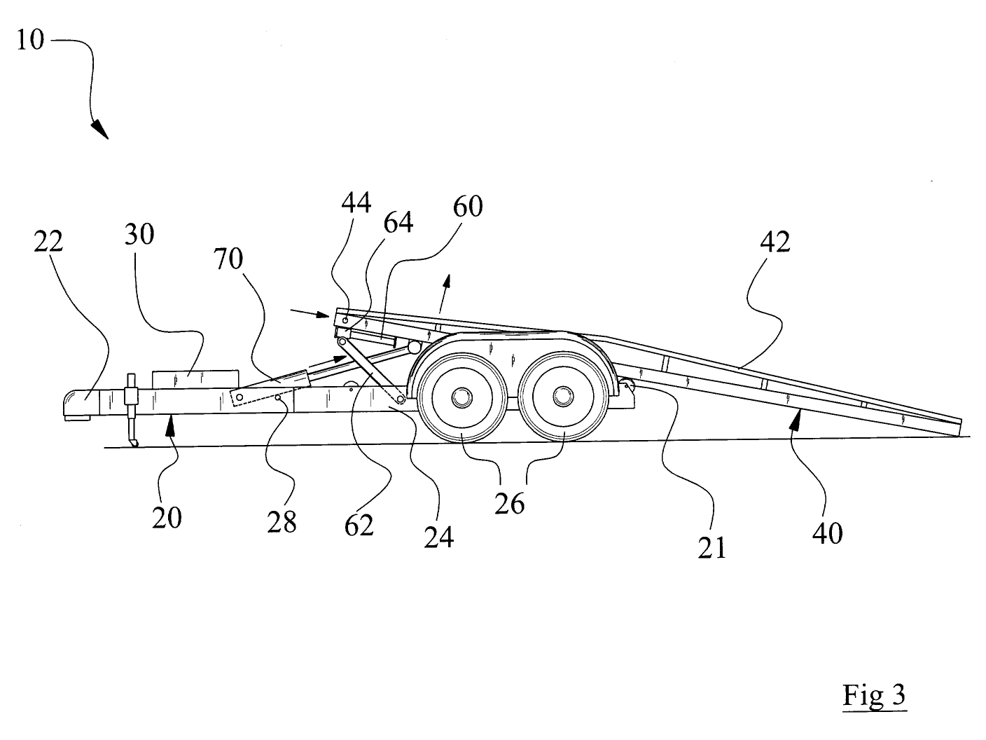

As best shown in FIGS. 3 through 7 of the drawings, the main frame 20 has a generally broad structure. The main frame 20 may be comprised of various frame structures and materials which are commonly utilized within the trailer industry. A plurality of wheels 26 are rotatably attached to the main frame 20. FIGS. 3 through 5 best illustrate that the wheels 26 are preferably attached to the main frame 20 near a rear end thereof. A hitch structure 22 preferably extends forwardly from the front of the main frame 20 for connecting to a vehicle.

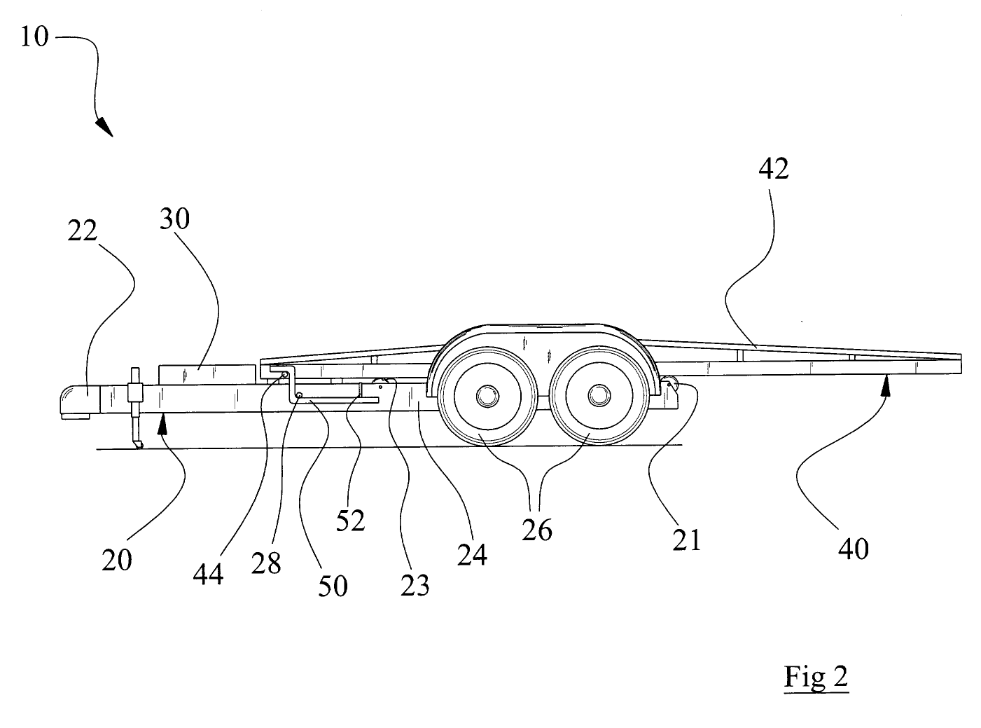

A plurality of end rollers 21 are rotatably attached to an upper portion of the main frame 20 as best shown in FIGS. 2, 3, 4, 6 and 7 of the drawings. The end rollers 21 are preferably positioned at or near the rear end of the main frame 20 for supporting the bed frame 40 as the bed frame 40 is extended as further shown in FIGS. 2, 3, 4, 6 and 7 of the drawings. A plurality of support rollers 23 are rotatably attached to the upper portion of the main frame 20 and are positioned within the front to middle portions of the main frame 20 for supporting the bed frame 40 when retracted.

A hydraulic unit 30 is attached to the main frame 20 and is capable of generating sufficient hydraulic fluid pressure for manipulating the bed frame 40 with a heavy load. The hydraulic unit 30 is preferably powered electrically from the attached vehicle or battery. However, the hydraulic unit 30 may be operated utilizing a gas motor or the like.

As shown in FIGS. 1 through 7 of the drawings, the bed frame 40 includes a bed platform 46 forming a substantially flat and straight structure. The bed frame 40 is mainly supported upon the end rollers 21 and support rollers 23. The bed frame 40 and bed platform 46 may have various other configurations other than that illustrated within the drawings for supporting various types of loads. A pair of side rails 42 preferably extend from the opposing sides of the bed frame 40 as best shown in FIG. 1 of the drawings. Various other configurations may be utilized to construct the bed structure of the present invention.

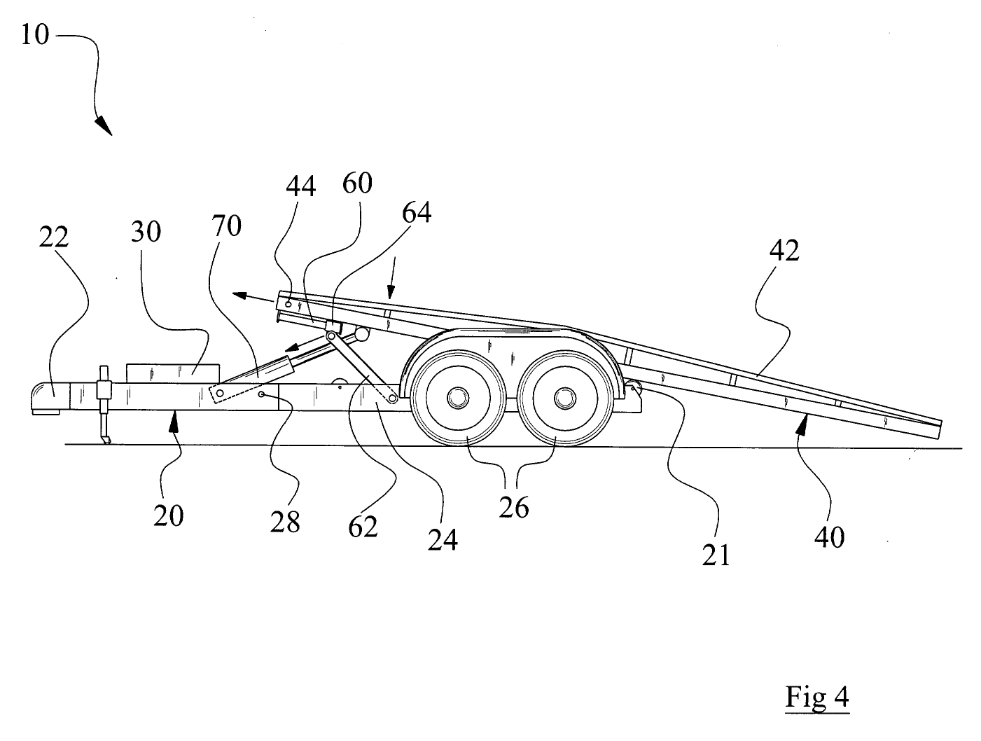

As shown in FIGS. 2 through 5 of the drawings, a plurality of guide shafts 60 are secured longitudinally to the lower portion of the bed frame 40 or the bed platform 46. The guide shafts 60 are spaced a finite distance from the lower surface of the bed platform 46 and the distal ends of the guide shafts 60 are secured to the bed platform 46 as best illustrated in FIG. 4 of the drawings.

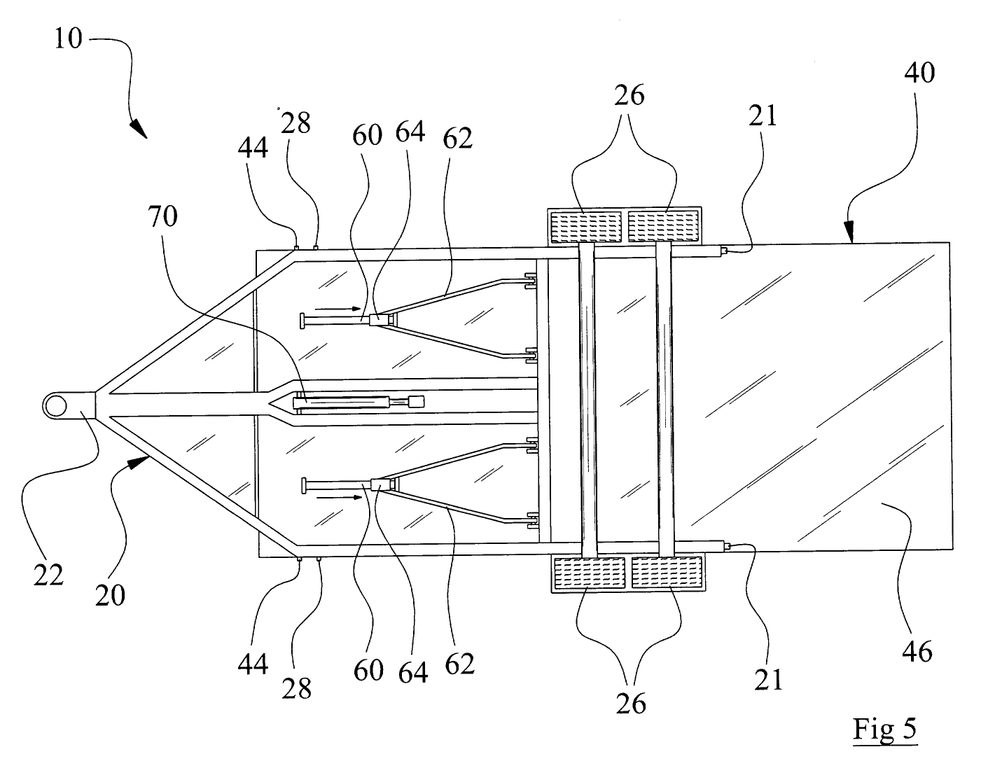

As further shown in FIGS. 3 through 5 of the drawings, collar members 64 are slidably attached about the guide shafts 60. A plurality of support arms 62 are pivotally attached correspondingly to the collar members 64. The opposing ends of the support arms 62 are pivotally attached to the main frame 20 as best shown in FIGS. 3 through 5 of the drawings. The support arms 62 preferably have a V-shaped structure as shown in FIG. 5 of the drawings.

As shown in FIGS. 3 and 4 of the drawings, at least one hydraulic cylinder is pivotally connected between the main frame 20 and the bed frame 40 or bed platform 46. The hydraulic cylinder is fluidly connected to the hydraulic unit 30. By manipulating a control valve, the operator is able to extend or retract the hydraulic cylinder. When the hydraulic cylinder is extended, the front of the bed frame 40 is elevated and the bed frame 40 is forced rearwardly as shown in FIG. 3 of the drawings. When the hydraulic cylinder is retracted, the front of the bed frame 40 is lowered and the bed frame 40 is forced forwardly as shown in FIG. 4 of the drawings.

As shown in FIGS. 1 through 7 of the drawings, one or more first catch members 28 are attached to the side of the main frame 20, and one or more second catch members 44 are attached to the side of the bed frame 40. A locking member 50 having a Z-shaped structure is provided with an elongate lower handle portion. An engaging portion 52 extends upwardly from the handle portion having a cuff structure for selectively engaging the main frame 20 as shown in FIG. 2 of the drawings. The upper portion of the locking member 50 extends about the second catch member 44 and the lower handle portion extends about the first catch member 28 with the engaging portion 52 maintaining a desired amount of pressure upon thereof for preventing the bed frame 40 from accidentally moving rearwardly or upwardly as shown in FIG. 2 of the drawings.

In use, the user removes the locking member 50 from the first catch member 28 and the second catch member 44. The user then manipulates the controls for the hydraulic unit 30 thereby causing the hydraulic cylinder to extend. As the hydraulic cylinder extends, the front portion of the bed frame 40 is elevated simultaneously while the bed frame 40 is slid rearwardly as shown in FIG. 3 of the drawings. The support arms 62 assist in guiding the bed frame 40 allowing the bed frame 40 to pivot and move rearwardly in a controlled manner. The bed frame 40 rolls upon the end rollers 21 as the front of the bed frame 40 is elevated. The rearward movement of the bed frame 40 assists in maintaining a lower incline for the bed platform 46 for easy loading of the load. Once the hydraulic cylinder is fully extended with the rear end of the bed frame 40 near or upon the ground surface, the user then loads the cargo onto the bed platform 46. After the cargo is properly loaded, the user then manipulates the hydraulic unit 30 thereby causing the hydraulic cylinder to retract. As the hydraulic cylinder retracts, the front of the bed frame 40 is lowered while the bed frame 40 is simultaneously drawn forwardly as shown in FIG. 4 of the drawings. When the bed frame 40 is properly positioned upon the main frame 20, the user then secures the locking member 50 about the first catch member 28 and the second catch member 44 to prevent accidental movement of the bed frame 40.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed to be within the expertise of those skilled in the art, and all equivalent structural variations and relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A tilting flatbed trailer system, comprising:
a main frame having a plurality of wheels rotatably attached thereto;
at least one end roller attached to a rear portion of said main frame;
a bed structure movably positioned upon said end roller;
a support arm pivotally attached to said main frame and slidably connected to a front portion of said bed structure; and
an actuator member connected between said main frame and said bed structure.

2. The tilting flatbed trailer system of claim 1, including a guide shaft attached longitudinally to said bed structure, wherein said support arm is slidably attached to said guide shaft.

3. The tilting flatbed trailer system of claim 2, wherein said support arm have a V-shaped structure.

4. The tilting flatbed trailer system of claim 1, wherein said support arm have a V-shaped structure.

5. The tilting flatbed trailer system of claim 1, wherein said bed structure is comprised of a bed frame and a bed platform attached to said bed frame.

6. The tilting flatbed trailer system of claim 1, wherein said end rollers are positioned at a distal rear end of said main frame.

7. The tilting flatbed trailer system of claim 1, wherein said actuator member extends rearwardly at an angle from said main frame.

8. The tilting flatbed trailer system of claim 1, including a guide shaft attached longitudinally to said bed structure and a collar member slidably positioned upon said guide shaft, wherein said support arm is pivotally attached to said collar member.

9. The tilting flatbed trailer system of claim 1, including support rollers rotatably attached to said main frame for movably supporting said bed structure.

10. The tilting flatbed trailer system of claim 9, wherein said end rollers are positioned at a distal rear end of said main frame.

11. A tilting flatbed trailer system, comprising:
a main frame having a plurality of wheels rotatably attached thereto;
at least one end roller attached to a rear portion of said main frame;
a bed structure movably positioned upon said end roller;
a support arm pivotally attached to said main frame and slidably connected to a front portion of said bed structure;
an actuator member connected between said main frame and said bed structure; and
a locking structure attached to said main frame and said bed structure for selectively securing said bed structure to said main frame.

12. The tilting flatbed trailer system of claim 11, including a guide shaft attached longitudinally to said bed structure, wherein said support arm is slidably attached to said guide shaft.

13. The tilting flatbed trailer system of claim 12, wherein said support arm have a V-shaped structure.

14. The tilting flatbed trailer system of claim 11, wherein said support arm have a V-shaped structure.

15. The tilting flatbed trailer system of claim 11, wherein said bed structure is comprised of a bed frame and a bed platform attached to said bed frame.

16. The tilting flatbed trailer system of claim 11, wherein said end rollers are positioned at a distal rear end of said main frame.

17. The tilting flatbed trailer system of claim 11, wherein said actuator member extends rearwardly at an angle from said main frame.

18. The tilting flatbed trailer system of claim 11, including a guide shaft attached longitudinally to said bed structure and a collar member slidably positioned upon said guide shaft, wherein said support arm is pivotally attached to said collar member.

19. The tilting flatbed trailer system of claim 11, including support rollers rotatably attached to said main frame for movably supporting said bed structure.

20. The tilting flatbed trailer system of claim 11, wherein said locking structure is comprised of:
a first catch member attached to said main frame;
a second catch member attached to said bed frame; and
a locking member having a Z-shaped structure positionable about said first catch member and said second catch member, wherein said locking member includes an engaging portion for selectively engaging said main frame.
